(19) United States
(12) Patent Application Publication
(10) Pub. No.: US 2023/0022798 A1
(43) Pub. Date: Jan. 26, 2023

(54) RANDOM ACCESS PREAMBLE TRANSMISSION AND RECEPTION IN NON-TERRESTRIAL NETWORK COMMUNICATIONS

(71) Applicant: MediaTek Singapore Pte. Ltd., Singapore (SG)

(72) Inventors: Dan LI, Shanghai (CN); Shiang-Jiun LIN, Hsinchu City (TW); Xuancheng ZHU, Shanghai (CN); I-Kang FU, Hsinchu City (TW)

(21) Appl. No.: 17/783,970

(22) PCT Filed: Dec. 10, 2020
(86) PCT No.: PCT/CN2020/135167

§ 371 Date: Jun. 9, 2022

(30) Foreign Application Priority Data
Dec. 13, 2019 (CN) 201911281638.6

(51) Int. Cl. H04B 7/01; G01S 19/08; H04W 74/08; H04J 13/00

(52) U.S. Cl. CPC H04B 7/01; G01S 19/08; H04W 74/0833; H04J 13/0062; H04W 84/06

(57) ABSTRACT

The present disclosure proposes schemes, techniques, designs and methods pertaining to transmission and reception of random access preambles to aid integration of terrestrial mobile network communication and non-terrestrial network (NTN) communication. The design of a proposed preamble is suitable for terrestrial mobile networks and for transmission scenarios with Doppler frequency shift and long propagation delay in NTN communications. The structure of the proposed preamble is used in random access of terrestrial and NTNs. The structure of the preamble can be modified based on the preamble design used for terrestrial network communication, so that it can be used in the random access of NTNs.

### CROSS REFERENCE TO RELATED APPLICATIONS

The present disclosure is part of an international patent application claiming the priority benefit of China Patent Application No. 201911281638.6, filed 13 Dec. 2019, the content of which being herein incorporated by reference in its entirety.

### FIELD OF THE INVENTION

The present disclosure is generally related to wireless communications and, more particularly, to transmission and reception of random access preambles to aid integration of terrestrial mobile network communication and non-terrestrial network (NTN) communication.

### BACKGROUND OF THE INVENTION

Unless otherwise indicated herein, approaches described in this section are not prior art to the claims listed below and are not admitted as prior art by inclusion in this section.

The convergence of NTN communication and terrestrial mobile network communication is a way of providing global network coverage. NTN communications can supplement terrestrial mobile networks wherever necessary. Additionally, NTNs can provide communication services in areas where there is no terrestrial mobile network services, such as oceans, deserts, mountains and high altitudes. In addition, NTN communications can also be used as a backup solution for terrestrial networks. When terrestrial network services are unavailable for some reason, a terminal (herein interchangeably referred to as a user equipment (UE)) can attempt to communicate through a NTN.

Regarding the integration of NTN communication and terrestrial mobile network communication, the same communication architecture and the same waveform can be used. Through lower-layer integration of the communication systems, development cost of terminals/UEs and base stations can be greatly reduced. Take terminal development as an example, the integration scheme of NTN communication and terrestrial mobile network communication allows usage of a chip in terrestrial and non-terrestrial network communications. Compared with the need for two sets of equipment for individual support, the cost of a terminal can thus be reduced.

However, NTN communications and terrestrial network communications have significantly different physical characteristics in signal frequency shift and propagation delay. As such, there remains challenges in the integration of NTN communications and terrestrial network communications.

### SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure aims to provide schemes, solutions, concepts, designs, methods and systems to address aforementioned issue associated with different physical characteristics in signal frequency shift and propagation delay between NTN communications and terrestrial network communications. Specifically, various proposed schemes in accordance with the present disclosure aim to provide solutions pertaining to transmission and reception of random access preambles to aid integration of terrestrial mobile network communication and NTN communication.

In one aspect, a method may involve determining a location of a non-terrestrial (NT) network node of an NTN relative to a UE. The method may also involve compensating for either or both of a frequency shift and a propagation delay in transmission of a preamble in a random access procedure between the UE and the NT network node based at least in part on the location of the NT network node relative to the UE.

In another aspect, a method may involve determining an aspect of a preamble. The method may also involve compensating for either or both of a frequency shift and a propagation delay in transmission of the preamble in a random access procedure between a UE and an NT network node of an NTN.

It is noteworthy that, although description provided herein may be in the context of certain radio access technologies, networks and network topologies such as narrowband Internet of Things (NB-IoT) and NTN, the proposed concepts, schemes and any variation(s)/derivative(s) thereof may be implemented in, for and by other types of radio access technologies, networks and network topologies such as, for example and without limitation, 5^{th} Generation (5G) and New Radio (NR), Long-Term Evolution (LTE), LTE-Advanced, LTE-Advanced Pro, Internet of Things (IoT) and Industrial Internet of Things (IIoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of a communication system including a terminal supporting terrestrial mobile network communication and NTN communication in accordance with various implementations of the present disclosure.

FIG. 2 is a diagram of an example scenario of Doppler shift in signal frequency of a low-orbit satellite system.

FIG. 3 is a diagram of an example scenario of residual Doppler frequency shift after pre-compensation of the Doppler frequency shift of a low-orbit satellite system.

FIG. 4 is a diagram of an example of an NB-IoT preamble symbol group in accordance with an implementation of the present disclosure.

FIG. 5 is a diagram of an example scenario of common propagation delay and differential propagation delay of a low-orbit satellite.

FIG. 6 is a diagram of an example of a preamble pattern for random access in an NB-IoT system in accordance with an implementation of the present disclosure.

FIG. 7 is a diagram of an example of a division of a preamble pattern into a large-frequency-shift tolerance portion and a small-frequency-shift tolerance portion for flexible scheduling in a non-terrestrial system in accordance with an implementation of the present disclosure.

FIG. 8 is a diagram of an example of common propagation delay compensation in accordance with an implementation of the present disclosure.

FIG. 9 is a diagram of an example scenario of segment detection of a repetitive preamble sequence in accordance with an implementation of the present disclosure..

FIG. 10 is a diagram of an example scenario of sliding window detection of a repetitive preamble sequence in accordance with an implementation of the present disclosure.

FIG. 11 is a block diagram of an example communication system in accordance with an implementation of the present disclosure.

FIG. 12 is a flowchart of an example process in accordance with an implementation of the present disclosure.

FIG. 13 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to transmission and reception of random access preambles to aid integration of terrestrial mobile network communication and NTN communication. According to the present disclosure, a number of possible solutions may be implemented separately or jointly. That is, although these possible solutions may be described below separately, two or more of these possible solutions may be implemented in one combination or another.

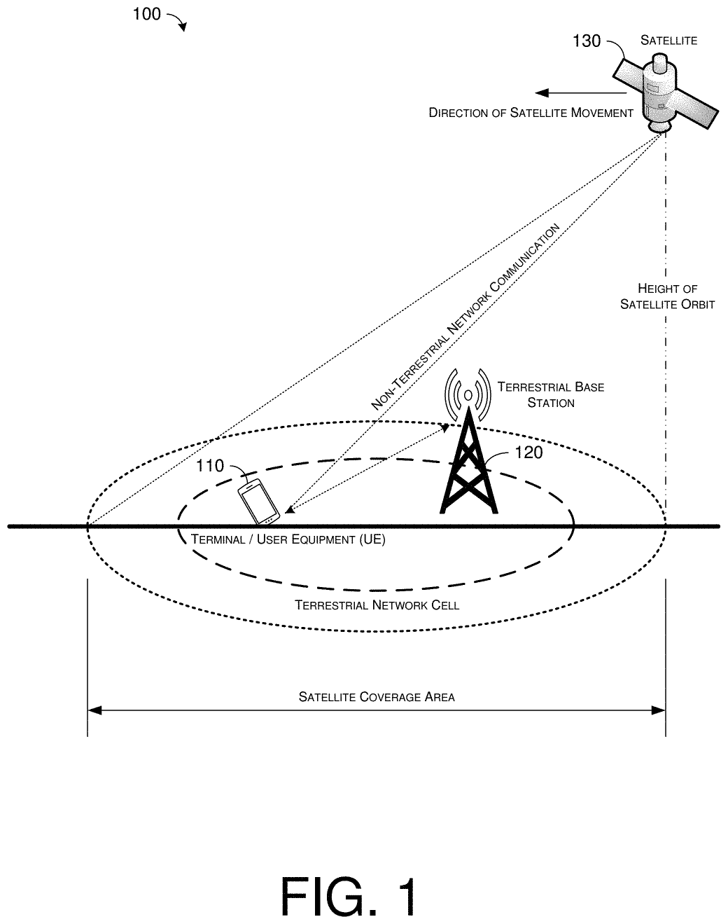

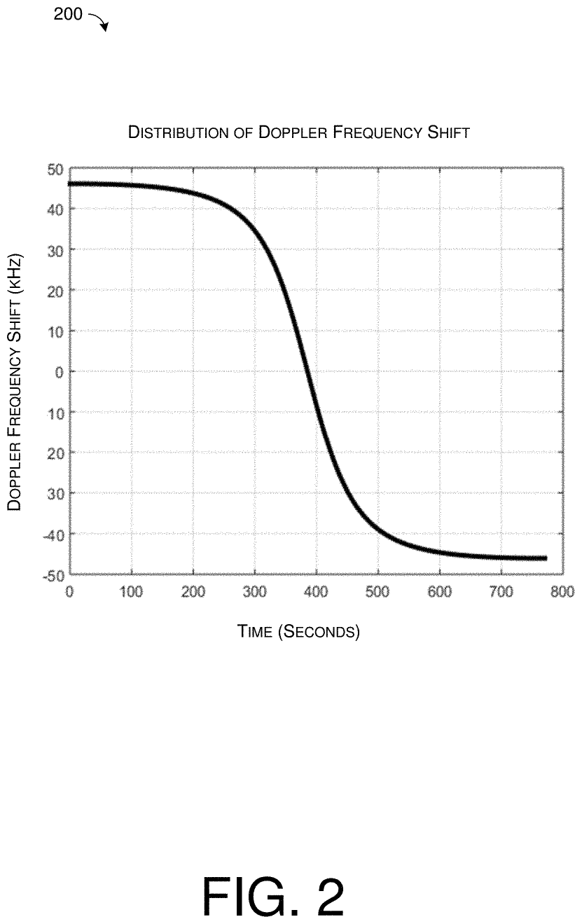

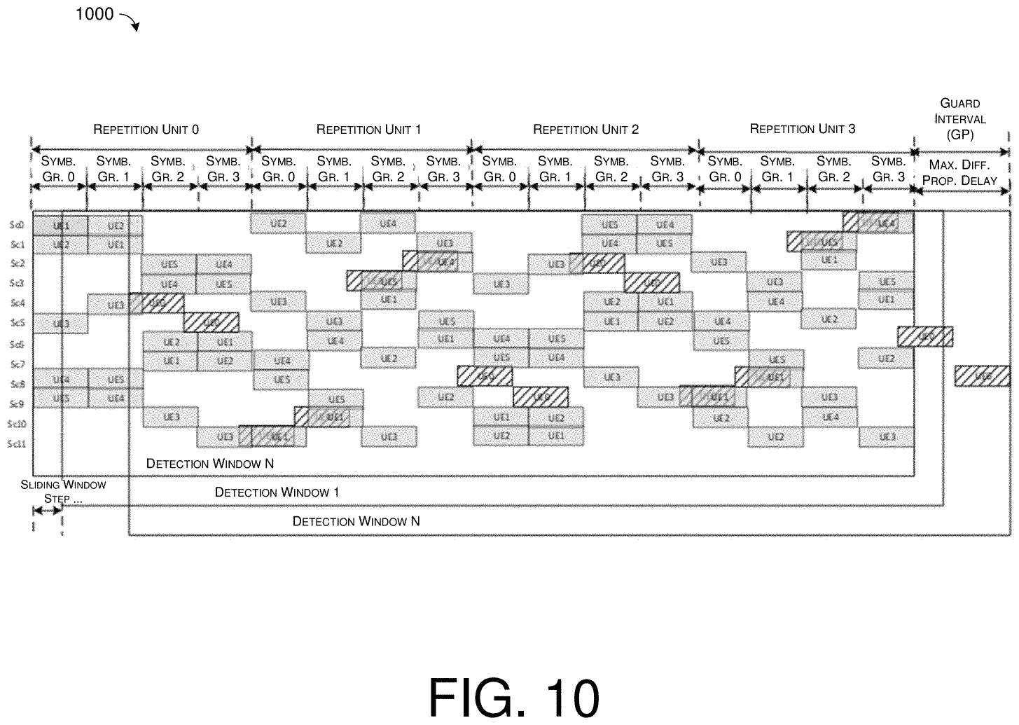

FIG. 1 illustrates an example communication system 100 in accordance with various implementations of the present disclosure. FIG. 2 ˜FIG. 10 illustrate examples related to proposed schemes and various implementations of the present disclosure. The following description of various proposed schemes of the present disclosure is provided with reference to FIG. 1˜FIG. 10.

Referring to FIG. 1, communication system 100 may involve a terminal or UE 110 supporting terrestrial mobile network communication and NTN communication. UE 110 may be in communication with a base station 120 of a terrestrial mobile network (not shown), such as a public land mobile network (PLMN) for example, and a satellite 130 of an NTN (not shown). Base station 120 may be a network node of terrestrial mobile network, and satellite 130 may be a network node of the NTN. That is, base station 120 may be considered a terrestrial network node and satellite 130 may be considered a non-terrestrial network node. Base station 120 may be a gNB, eNB or transmit-receive point (TRP). Satellite 130 may be a low-orbit satellite that orbits the Earth at an altitude of 600 kilometers (km) above the ground. Moreover, the speed of satellite 130 may be 7.56 km per second (km/s), for example. In communication system 100, each of UE 110, base station 120 and satellite 130 may be configured to implement various schemes pertaining to transmission and reception of random access preambles to aid integration of terrestrial mobile network communication and NTN communication in accordance with the present disclosure, as described below.

With respect to signal frequency shift in NTNs, taking satellite 130 as an example, a Doppler shift on a signal caused by the high-speed movement of satellite 130 is quite huge for ground terminals such as UE 110. Given a carrier frequency of 2 GHz and with UE 110 being stationary, the maximum Doppler shift in signal frequency experienced by UE 110 would be 46 kHz in case network coverage of UE 110 by satellite 130 begins at a terminal elevation angle of 0 degree. FIG. 2 shows an example scenario 200 of a Doppler shift in signal frequency of low-orbit satellite 130 orbiting at an altitude of 600 km.

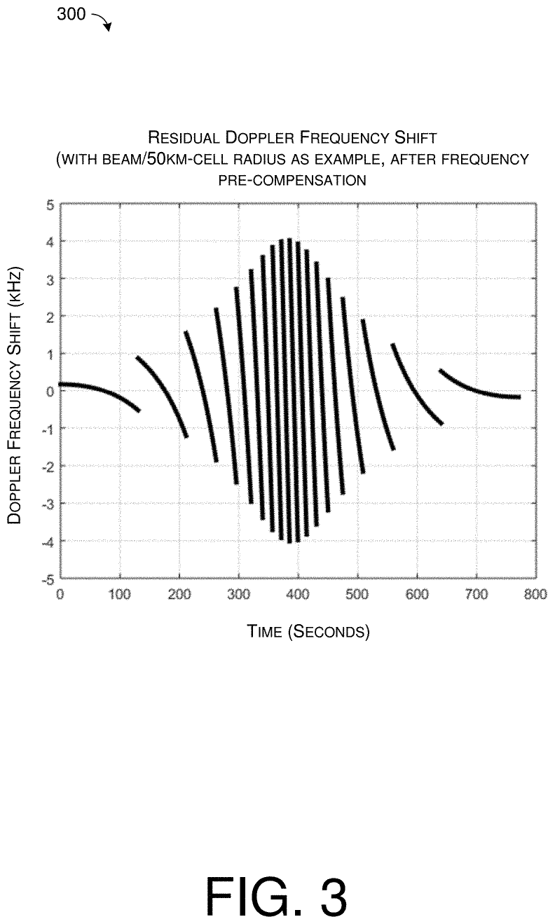

In some cases, satellite 130 may divide its coverage into multiple ground cells, with each cell formed by one or more respective satellite antenna beams. Moreover, satellite 130 may perform Doppler frequency pre-compensation for a fixed point, such as a center point of each beam (beam center) or a point having the shortest propagation delay among points/locations within coverage of the beam for example, to cause the Doppler shift of a received signal at the center point of the beam to be 0 Hz. FIG. 3 shows an example scenario 300 of distribution of a residual Doppler frequency shift of low-orbit satellite 130 at an altitude of 600 km after frequency pre-compensation. Accordingly, the maximum signal frequency shift experienced by UE 110 would be 4 kHz. Advantageously, the pre-compensation of satellite frequency shift would greatly reduce the maximum signal frequency shift experienced by UE 110. However, UE 110 would still experience an abrupt change in frequency, or frequency hop, when changing cells.

With respect to signal delay in NTNs, since the communication distance between UE 110 and satellite 130 changes in time due to the movement of satellite 130, a signal delay of the NTN would be relatively large and time-varying compared to that of the terrestrial mobile network. As an example, low-orbit satellite 130 orbiting at an altitude of 600 km and assuming that network coverage of UE 110 by satellite 130 begins at a terminal elevation angle of 10 degrees, the maximum round-trip propagation delay from UE 110 to satellite 130 could reach 12.88 milliseconds (ms). With base station 120 being on the ground and satellite 130 being responsible for signal transmission, the maximum round-trip propagation delay from UE 110 to the ground base station 120 could reach 25.77 ms.

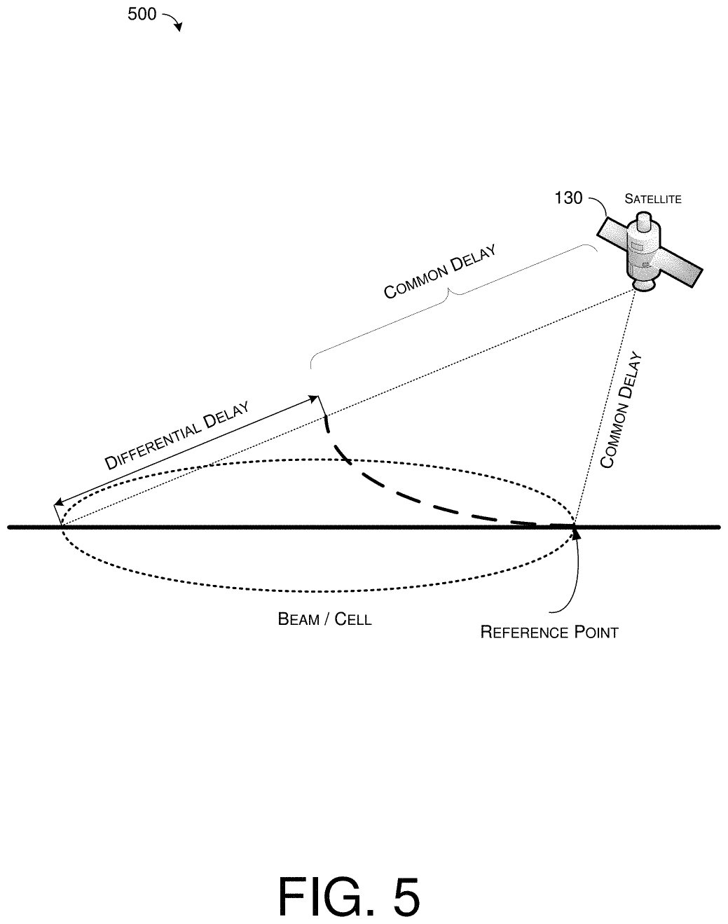

In order to utilize radio resources more efficiently as well as integrate NTN communications and terrestrial mobile network communications more efficiently, in some cases NTNs may divide the propagation delay into two parts. A point or location in a cell with the closest distance to satellite 130 may be taken as a reference point, and a propagation delay at this point may be regarded as the common propagation delay of the cell as it is the shortest propagation delay within the beam coverage. The propagation delay of other locations in the cell may be further divided into common propagation delay and differential propagation delay, as shown in FIG. 5. FIG. 5 shows an example scenario 500 of a common propagation delay and a differential propagation delay of low-orbit satellite 130 orbiting at an altitude of 600 km above the ground.

The common propagation delay in the cell may be jointly compensated by satellite 130, and the differential propagation delay may be supported by the design of communication system 100. Considering the high-speed movement of satellite 130, the ground cell coverage by and satellite beamforming may be much larger than that of terrestrial networks. Accordingly, the terrestrial preamble may need to be modified in order to support the operation of NTNs.

With respect to a preamble in accordance with various proposed schemes of the present disclosure, in the terrestrial mobile network a first step in a random access process may involve UE 110 transmitting an uplink (UL) preamble on a random access channel. After base station 120 successfully detects the preamble, base station 120 may estimate the timing advance parameters of UE 110 from which the preamble was transmitted. Then, base station 120 may allocate uplink resources to UE 110 so that UE 110 can obtain uplink synchronization and uplink resources in subsequent communication with base station 120.

One of the uses of the preamble may include allowing base station 120 to estimate the time of arrival (ToA) of the preamble. The arrival time of the preamble may reflect a round-trip propagation delay between base station 120 and UE 110. In orthogonal frequency-division multiplexing (OFDM)-based communication systems, such as a single-carrier frequency-division multiple-access (SC-FDMA) system, uplink signals received by base station 120 from different terminals/UEs need to be synchronized to a certain extent in order to maintain signal orthogonality and to avoid inter-symbol interference (ISI) between uplink signals. Therefore, a length of a cyclic prefix (CP) of the preamble may need to be greater than or equal to the round-trip propagation delay plus a maximum multipath delay spread caused by a multipath propagation effect. Moreover, a guard interval, or guard period (GP), may need to be greater than or equal to the round-trip propagation delay.

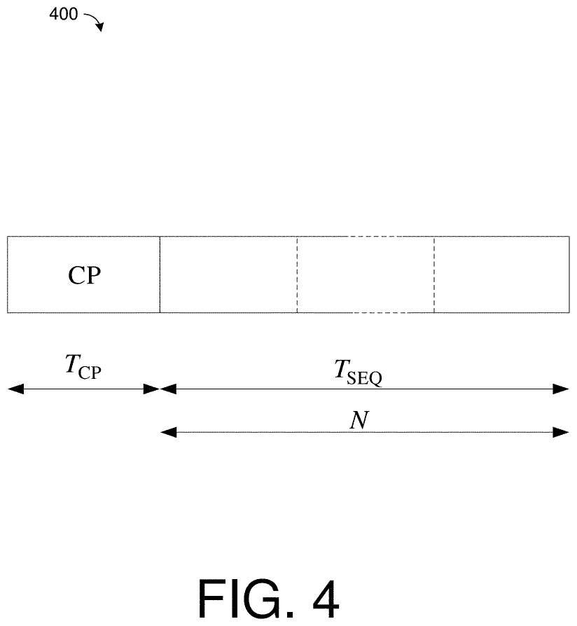

Taking the preamble design of an NB-IoT system as an example, the preamble of the 3^{rd} Generation Partnership Project (3GPP) Release 13 (R13) version is based on supporting terrestrial communication systems. The NB-IoT preamble may be based on a single carrier frequency hopping symbol group. A symbol group may include a cyclic prefix, with a length T_{CP}, and N identical symbols, with a length of T_{SEQ}, as shown in FIG. 4. The total number of symbol groups in the leading repetition unit is denoted by P, and the number of time continuous symbol groups is denoted by G, as shown in Table 1 below.

TABLE 1
Random Process Preamble Parameters

| Preamble | | | | | |
|---|---|---|---|---|---|
| Format | G | P | N | T_{CP} | T_{SEQ} |
| 0 | 4 | 4 | 5 | 2048Tₛ | 5 · 8192 Tₛ |
| 1 | 4 | 4 | 5 | 8192Tₛ | 5 · 8192 Tₛ |
| 2 | 6 | 6 | 3 | 24576Tₛ | 3.24576Tₛ |

The NB-IoT preamble may support single-carrier frequency hopping in the frequency domain. Different cells and different users may distinguish the preambles through different time-frequency resources. In the time domain, a symbol group may be used as a unit to repeat multiple times. In the frequency domain, the symbol groups may be hopped according to orthogonal codes. Each symbol group may be formed by multiple OFDM symbols with the same content. UE 110 may select an initial subcarrier through random selection or based on an instruction from base station 120, and UE 110 may transmit the preamble through a corresponding specific frequency hopping pattern. After detecting the preamble of this frequency hopping pattern, base station 120 may return a random access response (RAR) and carry out a subsequent random access procedure with UE 110. A relationship between NB-IoT preamble format, cyclic prefix length, subcarrier spacing, single repetition preamble length, and cell radius supported by the preamble is summarized in Table 2 below.

TABLE 2
NB-IoT Preamble Format

| 3GPP | Preamble | | Subcarrier | Preamble | Cell |
|---|---|---|---|---|---|
| Version | Format | CP Length | Spacing | Length | Radius |
| R-13 | 0 | 66.67 us | 3.75 kHz | 5.6 ms | 10 km |
| R-13 | 1 | 266.67 us | 3.75 kHz | 6.4 ms | 40 km |
| R-13 | 2 | 800 us | 1.25 kHz | 19.2 ms | 120 km |

In view of the above, the present disclosure proposes various schemes regarding transmission and reception of random access preambles to aid integration of terrestrial mobile network communication and NTN communication, as described below in the context of communication system 100. It is noteworthy that the various proposed schemes, methods and approaches described herein may be utilized individually or in combination.

### Proposed Schemes

Under various proposed schemes in accordance with the present disclosure, compensation for Doppler frequency shift in preamble transmission may be implemented in one or more ways. As mentioned above, the Doppler frequency shift of non-terrestrial communications may be divided into two parts. One part may be a frequency shift pre-compensated by a base station (e.g., base station 120) in a beam. The other part may be a residual frequency shift of a terminal (e.g., UE 110). The various proposed schemes (with each involving one or more approaches) with respect to compensating the Doppler frequency shit in preamble transmission are described below.

Under a first proposed scheme in accordance with the present disclosure, UE 110 may be configured with positioning capabilities, such as Global Navigation Satellite System (GNSS) capabilities. Accordingly, UE 110 may utilize its GNSS positioning capabilities (e.g., by utilizing any of Global Positioning System (GPS), Global Navigation Satellite System (GLONASS), Galileo, Beidou and other positioning methods) and, together with the location of satellite 130 according to an ephemeris of satellite 130, determine a location of satellite 130 relative to UE 110. This may be accomplished by either of two approaches as described below.

In a first approach, in an event that satellite 130 does not perform downlink (DL) frequency pre-compensation, UE 110 may estimate a downlink Doppler frequency shift caused by the movement of satellite 130 according to its relative location to satellite 130. Moreover, before the preamble is transmitted, UE 110 may pre-compensate for an uplink frequency shift, so that the frequency shift (due to Doppler effect) of the preamble received by satellite 130 may be equal to or at least close to 0 Hz.

In a second approach, in an event that satellite 130 performs downlink frequency pre-compensation, UE 110 may use its relative location to satellite 130 and other related information (such as a beam identification (ID), an estimated frequency shift, and/or other cell-related information) to estimate a residual Doppler frequency shift. Moreover, before the preamble is transmitted, UE 110 may pre-compensate for an uplink frequency shift, so that the frequency shift (due to Doppler effect) of the preamble received by satellite 130 may be equal to or at least close to 0 Hz.

It is noteworthy that the first proposed scheme does not rely on exchange of system information and may achieve seamless switching/handover between cells. System performance may depend on the accuracy of frequency shift estimation by a terminal (e.g., UE 110).

Under a second proposed scheme in accordance with the present disclosure, a guard interval in the frequency domain may be reserved for tolerance of a frequency shift and a time delay (herein interchangeably referred to as “propagation delay”) in non-terrestrial communications. In general, due to the very large frequency shift and propagation delay associated with non-terrestrial systems, in case that all time-frequency resources are used to transmit a preamble, a very high false detection rate and/or a very high missed detection rate may result. Thus, under the second proposed scheme, the frequency shift and propagation delay associated with non-terrestrial systems may be tolerated by reserving a guard interval in the frequency domain when selecting one or more initial subcarriers of the preamble to be transmitted by a terminal (e.g., UE 110) under the second proposed scheme. This may be accomplished by either of two approaches as described below.

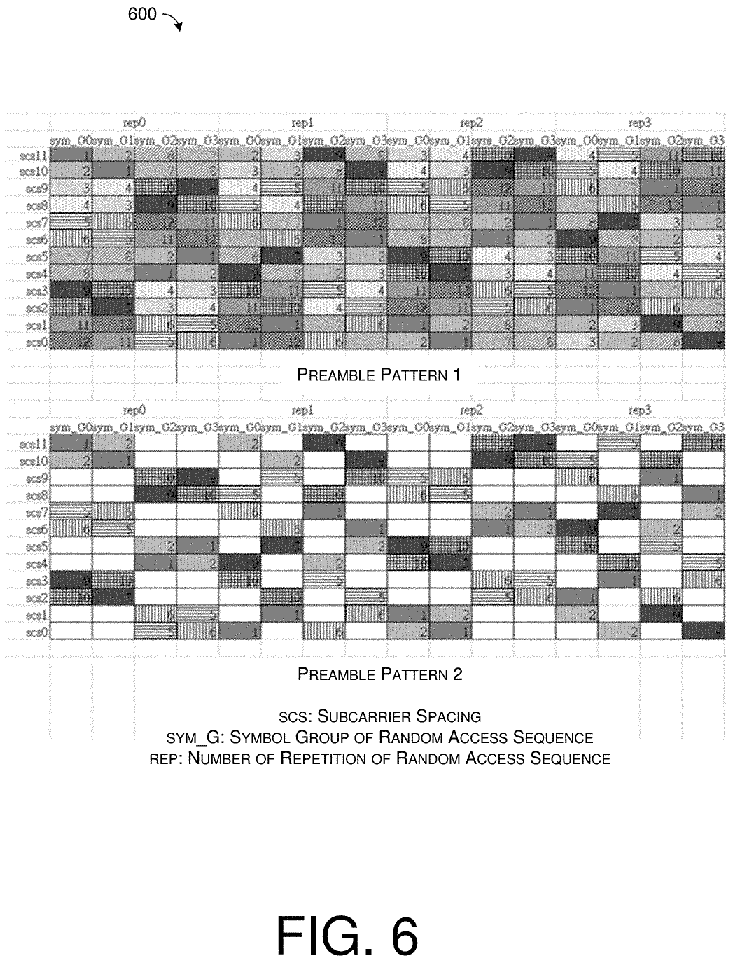

In a first approach, in a preamble pattern 1 such as that shown in example 600 of FIG. 6, different numbers may represent preamble resources that may be selected by different terminals/UEs or cells (e.g., in an NB-IoT system). In example 600, preamble pattern 1 may be a preamble pattern of conventional terrestrial communications (with no guard intervals), and preamble pattern 2 may be an example preamble pattern (with guard intervals) according to the second proposed scheme to counter Doppler frequency shift and propagation delay in non-terrestrial communications. Assuming that a frequency shift is denoted by f_{d} and a subcarrier spacing is denoted by Δf, then in case of |f_{d}|>=Δf, the preamble patterns of two different terminals/UEs may completely overlap each other, and it may be impossible to distinguish these two different terminals/UEs (such as user 1 and user 3 in example 600 of FIG. 6). In case of 1/2*Δf<=<=|f_{d}|<Δf, a particularly high false detection rate may result due to mutual interference between the preambles of different terminal s/UEs

To address the aforementioned issue, in the first approach, a range of selectable initial subcarriers (e.g., subcarriers available for initial selection) may be limited to, for example and without limitation, {2,3,6,7 . . . , N_{sc}^{NPRACH}−1}, so as to reserve a guard interval between selected subcarriers to ensure that there would be no confusion between terminals/UEs. As shown in preamble pattern 2 in FIG. 6, every pair of adjacent preamble patterns may be separated from another pair of adjacent preamble patterns in the frequency domain (the vertical axis in FIG. 6) by two subcarrier spacings that function as guard intervals. Similarly, in the time domain (the horizontal axis in FIG. 6), guard intervals each having a length of two symbol groups may be utilized to tolerate propagation delay. For instance, a guard interval may be extended to be greater than or equal to the round-trip propagation delay. Additionally or alternatively, a length of a cyclic prefix of a preamble may be extended to be greater than or equal to the round-trip propagation delay plus a maximum multipath delay caused by a multipath propagation effect.

In the first approach, base station 120 may detect the frequency shift by reserving a guard interval. As shown in FIG. 6, after receiving four preambles in a first repetition unit (denoted as “Rep0” in FIG. 6), the frequency shift may be estimated based on the position of the initial subcarrier of the preamble and the orthogonality of the preamble pattern. Accordingly, by detection of subsequent repetition units, the frequency shift may be pre-compensated. For frequency shift of 1/2* Δf<=|f_{d}|<Δf, when two UEs have adjacent initial carrier frequencies, one half of the preamble carriers may interfere with each another while the other half of the preamble carriers may not cause interference. Thus, the complete pattern may be estimated by detecting half of the pattern.

It is noteworthy that the first approach does not require any changes to the transmission of the physical layer preamble of an existing NB-IoT, as long as the range of selectable initial subcarrier indices is limited. In this way, preamble transmission in terrestrial communication and non-terrestrial communication may be consistent.

In a second approach, preamble sequences of the terrestrial network may be the same in symbols. Orthogonality may be achieved through a single carrier frequency hopping pattern, which is resistant to channel fading. In the time domain, multiple repetitions in symbol groups may be performed. In the frequency domain, symbol groups may be hopped according to an orthogonal pattern. Each symbol group may have multiple OFDM symbols with the same content.

It is noteworthy that the preamble sequence of the NTN may be a sequence with mutually orthogonal symbols. The sequence may be, for example and without limitation, an M sequence, a Gold sequence, a double-root Zadoff-Chu (ZC) sequence or the like. By reserving guard interval(s) in the frequency domain, frequency shift and propagation delay in non-terrestrial systems may be tolerated.

Under a third proposed scheme in accordance with the present disclosure, the preamble pattern may be dynamically selected based on a priori information. For instance, base station 120 may, through system messaging and/or dedicated signaling, inform UE 110 of the elevation angle of the satellite beam and whether the current communication is terrestrial or non-terrestrial. The a priori information may include, for example and without limitation, the elevation angle of the satellite beam and an indication of whether the communication is terrestrial or non-terrestrial.

Referring to FIG. 6, with respect to a preamble pattern for random access in an NB-IoT system, preamble pattern 1 may be a preamble pattern of conventional terrestrial communications, whereas preamble pattern 2 may be a preamble pattern for non-terrestrial communication systems to counter Doppler frequency shift and large propagation delay in accordance with the present disclosure. For beams with a residual Doppler frequency shift not exceeding the subcarrier spacing Δf after satellite pre-compensation for common Doppler frequency shift, preamble pattern 1 in FIG. 6 may be selected, as this may be sufficient to tolerate frequency shift and may increase the number of terminals/UEs connected simultaneously. On the other hand, for beams with a residual Doppler frequency shift exceeding the subcarrier spacing Δf after satellite pre-compensation for common Doppler frequency shift, preamble pattern 2 in FIG. 6 may be selected (at the expense of the maximum number of terminals/UEs connected simultaneously) to ensure system performance on the receiving side. For terrestrial communications, preamble pattern 1 may be used.

Under a fourth proposed scheme in accordance with the present disclosure, resources for random access may be divided into a large-frequency-shift tolerance portion (using preamble pattern 2) and a small-frequency-shift tolerance portion (using preamble pattern 1). Accordingly, a terminal (e.g., UE 110) may self-train, select or otherwise determine a suitable portion of available time-frequency resources for preamble transmission. A ratio between the large-frequency-shift tolerance portion and the small-frequency-shift tolerance portion may be dynamically adjusted according to a priori information including, but not be limited to, the satellite beam elevation angle.

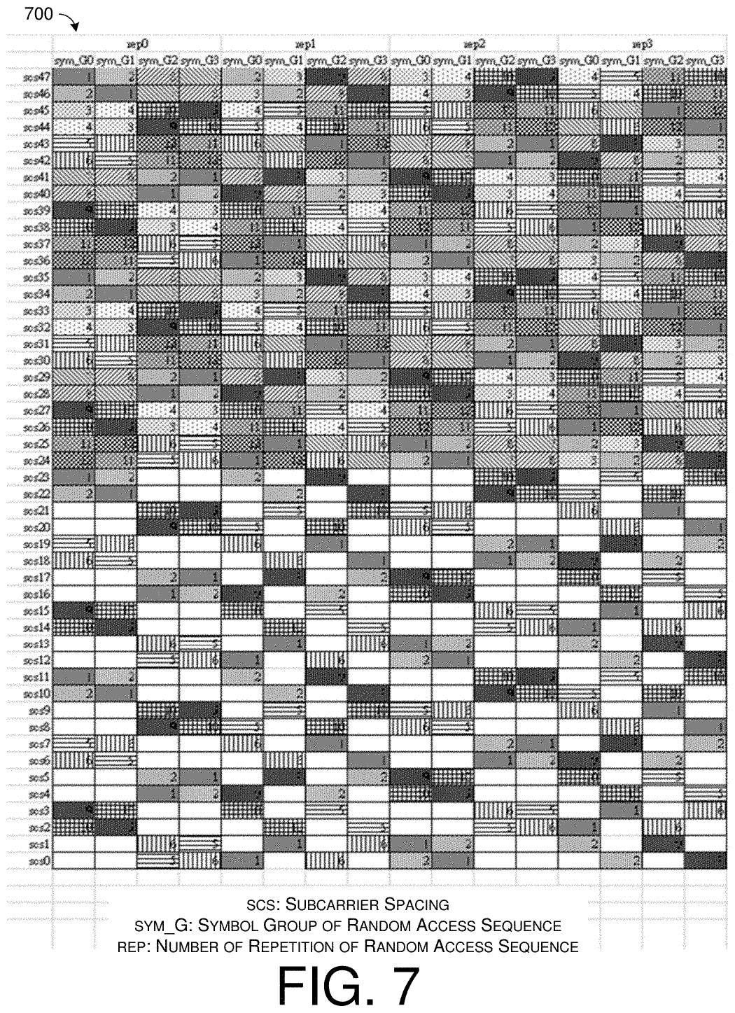

FIG. 7 illustrates an example 700 of a division of a preamble pattern (in terms of time-frequency resources) into a large-frequency-shift tolerance portion and a small-frequency-shift tolerance portion for flexible scheduling in a non-terrestrial system in accordance with an implementation of the present disclosure. Referring to FIG. 7, the division of the preamble pattern into the large-frequency-shift tolerance portion and the small-frequency-shift tolerance portion may be based on a density of users/UEs, a number of users/UEs that are simultaneously accessing a cell, a satellite beam elevation angle with respect to a terminal, different common frequency shift compensation methods, and so on.

Under the fourth proposed scheme, the division of the preamble pattern into the large-frequency-shift tolerance portion and the small-frequency-shift tolerance portion may be dynamically adjusted according to a ratio between a number of users/UEs with a relatively large frequency shift and a number of users/UEs with a relatively small frequency shift in a cell. For instance, for NB-IoT applications under a low-Earth-orbit (LEO) satellite at an altitude of 600 km, in an event that the number of users/UEs with a low-elevation-angle cell frequency shift greater than or equal to a predetermined value is relatively small, the proportion of the small-frequency-shift tolerance portion may be increased. Otherwise, in an event that the number of users/UEs with a high-elevation-angle cell frequency shift greater than or equal to the predetermined value is relatively large, the proportion of the small-frequency-shift tolerance portion may be decreased. The predetermined value may be a preset value or it may be user-specified.

Under the fourth proposed scheme, there may be multiple methods for the terminal (e.g., UE 110) to self-train with respect to portions or areas in the preamble pattern. For instance, UE 110 may first select an initial portion (of time-frequency resources) in the preamble pattern to transmit the preamble and, in response to continuous failures in transmission after a period of time, UE 110 may switch to another portion (of time-frequency resources) in the preamble pattern for transmission. The selection of the initial portion may be based on, but not limited to, one or more of the following methods. A first method may involve UE 110 randomly selecting a portion or preferentially selecting a portion of a small frequency shift. A second method may involve UE 110 selecting a portion of a large frequency shift according to a ratio of a range of relatively large frequency shifts in the cell. A third method may involve UE 110 estimating its location in the cell to select the most suitable portion based on some a priori information such as, for example and without limitation, information on the time of cell handover/reselection, a rate of change in Doppler frequency shift, and so on.

It is believed that the above methods may achieve a good balance between the number of user access and the issue with frequency shift.

Under various proposed schemes in accordance with the present disclosure, compensation for propagation delay in preamble transmission may be implemented in one or more ways. As mentioned above, the propagation delay of non-terrestrial communications may be divided into two parts (as shown in FIG. 5). One part may be a common propagation delay pre-compensated by a base station (e.g., base station 120) in a beam. The other part may be a differential propagation delay remaining for each terminal (e.g., UE 110). The various proposed schemes (with each involving one or more approaches) with respect to compensating the propagation delay in preamble transmission are described below.

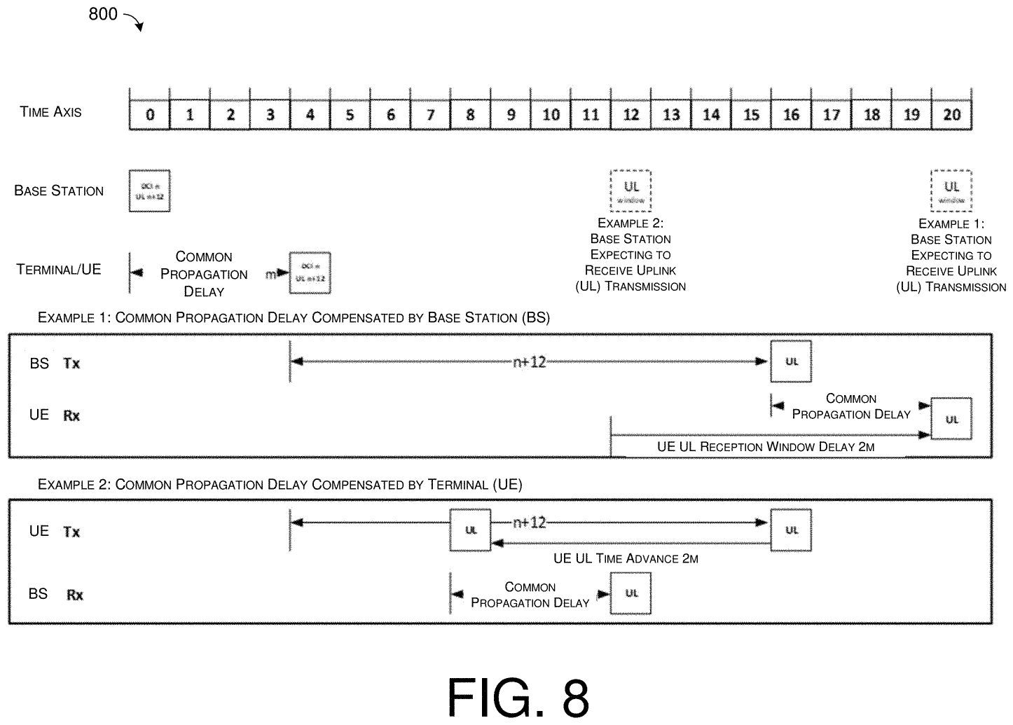

Under a first proposed scheme in accordance with the present disclosure, compensation for a common propagation delay may be achieved in either of two approaches. FIG. 8 illustrates an example 800 of common propagation delay compensation in accordance with an implementation of the present disclosure. In a first approach, the common propagation delay may be compensated by a base station (e.g., base station 120). A terminal (e.g., UE 110) may transmit an uplink signal (e.g., a preamble for random access) at a point in time indicated by the base station, and the base station may extend an uplink reception window by twice the duration of the common propagation delay to receive the uplink signal. This is shown as Example 1 in FIG. 8.

In a second approach, the common propagation delay may be compensated by the terminal. The terminal may begin uplink transmission in advance, with a duration of the uplink transmission being twice that of the common propagation delay, and transmit the uplink signal. The uplink receiving window of the base station may remain the same as an original estimated time, based on which the base station may receive the uplink signal. This is shown as Example 2 in FIG. 8.

Under a second proposed scheme in accordance with the present disclosure, the terminal may be configured with positioning capabilities such as GNSS capabilities, for example. For instance, UE 110 may utilize GNSS positioning and ephemeris of satellite 130 to determine the location of satellite 130 (relative to UE 110). UE 110 may then estimate a signal propagation delay. This may be accomplished by either of two approaches as described below.

In a first approach, it may be assumed that either a satellite (e.g., satellite 130) or a base station (e.g., base station 120) may perform common propagation delay compensation, and a terminal (e.g., UE 110) may, through system messaging and/or dedicated signaling from the satellite or base station, obtain information on a common propagation delay for the cell. Accordingly, the terminal may estimate a signal propagation delay based on its relative location to the satellite. The common propagation delay may be subtracted from the signal propagation delay to obtain a differential propagation delay. Before preamble transmission, the terminal may begin uplink transmission in advance, with a duration of the uplink transmission being twice that of the common propagation delay, and transmit the uplink signal. This may allow the base station to receive the preambles from different terminals within a given receiving window.

In a second approach, it may be assumed that the terminal (e.g., UE 110) may perform common propagation delay compensation and estimate a signal propagation delay based on its relative location to the satellite (e.g., satellite 130). The propagation delay may include a common propagation delay and a differential propagation delay. The terminal may begin uplink transmission in advance, with a duration of the uplink transmission being twice that of the common propagation delay, and transmit the uplink signal. This may allow the base station to receive the preambles from different terminals within a given receiving window.

It is noteworthy that the first proposed scheme does not rely on exchange of system information and may achieve seamless handover between cells. System performance may depend on the accuracy of frequency shift estimation by the terminal.

Under a third proposed scheme in accordance with the present disclosure, a large propagation delay in the satellite system may be compensated by using segmentation of repetitive preamble sequences without cyclic prefix and sliding window detection to compensate for the large delay of the satellite system.

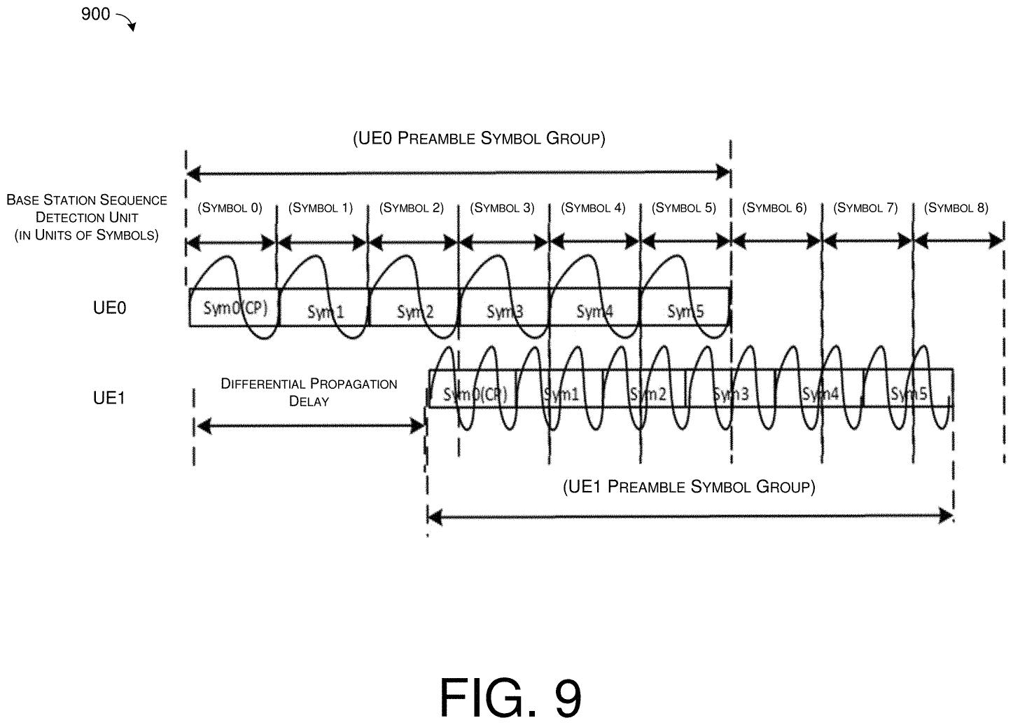

FIG. 9 illustrates an example scenario 900 of segmented detection of a repetitive preamble sequence in accordance with an implementation of the present disclosure. Taking the preamble of a conventional terrestrial communication NB IOT system as an example (as shown in FIG. 9), a preamble sequence symbol group may be composed of five OFDM symbols and a cyclic prefix (CP). The base station (e.g., base station 120) may use the preamble symbol group as a unit and, after removing the cyclic prefix, may perform subcarrier detection. Then, a detection window containing all preamble symbols may be used to detect the preamble sequence. For non-terrestrial communication networks, the differential propagation delays between different users/UEs may be relatively large and may even exceed the extent of the cyclic prefix, thereby destroying the orthogonality between the subcarriers of the users in units of symbol groups to result in reduced performance in detection.

For non-terrestrial communication networks, a preamble sequence may be considered as six effective OFDM symbols, and the conventional CP may not be used as a guard interval. During detection, the base station may use a single preamble symbol as a unit to detect subcarriers. As shown in FIG. 9, symbols 0/1/3/4/5 may be used to detect user 0; symbols 3/4/5/6/7 may be used to detect user 1; and symbols 2/8 may be probabilistically undetectable due to loss of orthogonality. This may be alright because, as the proportion of symbols that fail to be detected tends to be small, the probability of false detection for the entire symbol group may be very small. After multiple subcarrier detections, most of the preamble symbols in a preamble symbol group may be detected.

However, as the differential propagation delay may exceed one or more preamble symbol groups (e.g., for a near-Earth satellite with an altitude of 600 km the differential propagation delay may reach two preamble symbol groups), confusion between/among different preamble symbol groups may result, as shown in FIG. 10. FIG. 10 illustrates an example scenario 1000 of sliding window detection of a repetitive preamble sequence. In example scenario 1000, it may not be determined whether symbol group 2 of subcarrier 4 is the first symbol group delayed by user 1 or the third symbol group of other users without delay. Here, as in preamble pattern 2 of FIG. 6, reserved guard intervals may be used to counter frequency shift and propagation delay. Different users/UEs may be distinguished according to the orthogonality between the reserved guard interval(s) and preamble symbol group(s). During detection by the base station, with the sliding window detection method, the preamble sequence of each user/UE may be completely distinguished, and the respective timing advance of each user/UE may be estimated according to a phase difference of the sequence.

For the aforementioned method of preamble sequence detection using a sliding window, as shown in FIG. 10, a size of the sliding window may be that of a preamble sequence including all repetition units, and the sliding window step length may be a period of the preamble sequence phase reversal. The differential delay within the phase reversal period may be used to estimate the timing advance through the phase difference. The range of the sliding window may be the range of the maximum differential propagation delay.

It is noteworthy that, for segmented detection of a repetitive preamble sequence, one would merely need to modify the detection algorithm of the base station, in addition to reserving a certain guard interval during scheduling. There may be no difference for the terminal/UE between terrestrial communication and non-terrestrial communication, thereby achieving good compatibility.

In view of the proposed schemes described above, one of ordinary skill in the art would appreciate that the present disclosure provides various methods for supporting transmission and reception of random access preambles to aid integration of terrestrial mobile network communication and NTN communication such as, for example and without limitation, for an NB-IoT system. To aid better appreciation of the proposed schemes, various features of the proposed schemes are highlighted below.

In some implementations, a structure or pattern of a preamble may be modified so that the preamble may be used for random access in NTN communications.

In some implementations, preambles may be distinguished through different patterns of time-frequency resources. For instance, a base station may indicate an initial subcarrier range for preamble transmission, and a terminal may randomly select initial subcarriers for preamble transmission. Moreover, the terrestrial and non-terrestrial networks may share the same preamble sequence. Furthermore, given a difference in the selection ranges of initial subcarriers for preamble transmission, the preamble transmission by the terminal may be suitable for and used in both the terrestrial and non-terrestrial networks.

In some implementations, a configuration of initial subcarriers for preamble transmission in the terrestrial network may comprise N consecutive subcarriers. Moreover, a configuration of initial subcarriers for preamble transmission in the non-terrestrial network may comprise discontinuous subcarriers in the frequency domain to reserve guard interval(s) therebetween, thereby countering frequency shift and propagation delay in NTN communications.

In some implementations, with single-carrier preamble transmission resources, the base station may indicate a range of resources for preamble transmission, and the terminal may randomly select initial subcarriers for preamble transmission. Accordingly, a difference in preamble sequences may allow usage for random access in both the terrestrial and non-terrestrial networks.

In some implementations, preamble sequences for the terrestrial network may have the same symbols, and orthogonality may be achieved through single-carrier frequency hopping to counter channel fading. Moreover, preamble sequences for the non-terrestrial network may be sequences with mutually orthogonal symbols, with a guard interval reserved in the frequency domain, to counter frequency shift and propagation delay in NTN communications.

In some implementations, preambles for the terrestrial network may be repeated multiple times in the time domain in units of symbol groups. In the frequency domain, frequency hopping with an orthogonal pattern may be applied to the symbol groups. Each symbol group may be composed of multiple OFDM symbols with the same content. Furthermore, a preamble sequence for the non-terrestrial network may be an orthogonal sequence (that is, a sequence with mutually orthogonal symbols) with good anti-frequency shift characteristics. In some implementations, the preamble sequence may include an M sequence, a Gold sequence, a double-root ZC sequence.

In some implementations, for terrestrial communications, the terminal may perform random access based on a preamble pattern configured by the base station. For non-terrestrial communications, the base station may configure multiple preamble patterns as well as resources for preamble transmission, and the terminal may, based on a priori information, select one of the multiple preamble patterns and corresponding resource(s) for preamble transmission, thereby achieving a balance between preamble detectability and resource utilization. In some implementations, the a priori information may include information on a satellite beam elevation angle with respect to a terminal, an indication of whether the communication is terrestrial or non-terrestrial, information of a relative location between the satellite and the terminal, information of a terrestrial network (e.g., PLMN), or a combination thereof. In some implementations, the a priori information may be part of system information broadcasted by the base station to the terminal. Alternatively, or additionally, the a priori information may be transmitting from the base station to the terminal via dedicated signaling. Alternatively, or additionally, the a priori information may be determined by the terminal based on GNSS information and ephemeris of the satellite.

In some implementations, for terrestrial communications, the terminal may perform random access based on random access resources configured by the base station. For non-terrestrial communications, the base station may divide resources for random access into a large-frequency-shift tolerance portion and a small-frequency-shift tolerance portion. The terminal may select a portion for preamble transmission based on a priori information.

In some implementations, a ration between the large-frequency-shift tolerance portion and the small-frequency-shift tolerance portion may be dynamically adjusted based on a priori information. In some implementations, the a priori information may include information on a satellite beam elevation angle with respect to a terminal, an indication of whether the communication is terrestrial or non-terrestrial, information of a relative location between the satellite and the terminal, information of a terrestrial network (e.g., PLMN), or a combination thereof. In some implementations, the a priori information may be part of system information broadcasted by the base station to the terminal. Alternatively, or additionally, the a priori information may be transmitting from the base station to the terminal via dedicated signaling. Alternatively, or additionally, the a priori information may be determined by the terminal based on GNSS information and ephemeris of the satellite.

In some implementations, different preambles may be distinguished according to their time-frequency resource patterns. Accordingly, the base station may indicate a range of initial subcarriers for preamble transmission, and the terminal may randomly select initial subcarrier(s) among those in the range to transmit preamble(s). Moreover, the same preamble sequence may be shared for both terrestrial and non-terrestrial communications. Additionally, the terminal may estimate and pre-compensate for Doppler frequency shift and propagation delay between the terminal and satellite, thereby allowing a preamble for the terrestrial network to be used in the NTN.

In some implementations, in the terrestrial network, there is no need for the terminal to perform pre-compensation for Doppler frequency shift and propagation delay. On the other hand, in the NTN, the terminal may utilize its positioning capabilities (e.g., GNSS) and ephemeris of the satellite to estimate a location of the satellite relative to the terminal to estimate Doppler frequency shift and propagation delay in order to perform pre-compensation therefor.

In some implementations, in the terrestrial network, there is no need for the terminal to perform pre-compensation for Doppler frequency shift and propagation delay. On the other hand, in the NTN, the terminal may approximate an uplink frequency shift by tracking frequency shift(s) and propagation delay(s) in downlink transmission(s), and pre-compensate for uplink frequency shift in preamble transmission.

In some implementations, different preambles may be distinguished according to their time-frequency resource patterns. Accordingly, the base station may indicate a range of initial subcarriers for preamble transmission, and the terminal may randomly select initial subcarrier(s) among those in the range to transmit preamble(s). For the terrestrial network, each preamble symbol group may include a cyclic prefix and preamble symbols. For the NTN, each preamble symbol group may include multiple preamble symbols (without cyclic prefix), and sufficient guard intervals may be utilized for preamble sequences and other uplink signals. Accordingly, the terrestrial network and the NTN may utilize different preamble detection algorithms.

In some implementations, for the terrestrial network, with a single preamble symbol group being a unit, subcarrier detection may be performed after removing the cyclic prefix. Then, a detection window containing all preamble symbols may be used to detect the preamble sequence. For the NTN, with a single preamble symbol group being a unit for subcarrier detection, after performing subcarrier detection multiple times all the preamble symbols of a given preamble symbol group may be detected, and a sliding window may be used for preamble sequence detection. In some implementations, for preamble sequence detection with the sliding window, a periodicity of phase reversal of preamble sequence may be used as a unit in preamble sequence detection with the sliding window. A range of the sliding window may be a range of a maximum differential propagation delay.

In some implementations, based on the preamble sequence of the terrestrial network, the preamble of the NTN may be extended by extending the cyclic prefix and/or the guard interval to counter a relatively larger propagation delay of the NTN. In some implementation, either or both of the cyclic prefix and the guard interval may be extended to a maximum differential propagation delay range for non-terrestrial communications.

### Illustrative Implementations

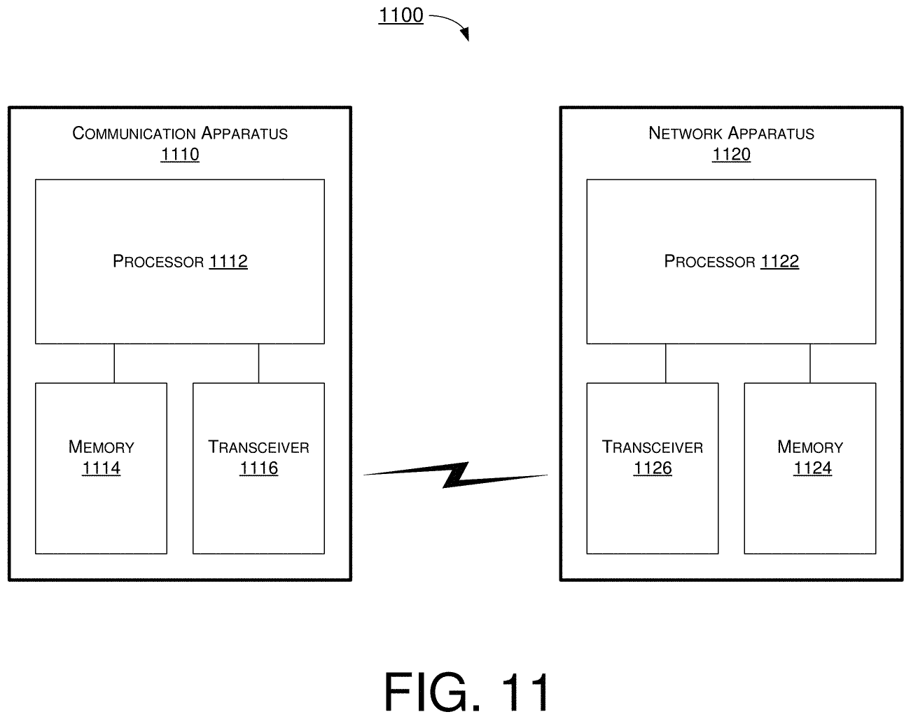

FIG. 11 illustrates an example communication system 1100 having an example apparatus 1110 and an example apparatus 1120 in accordance with an implementation of the present disclosure. Each of apparatus 1110 and apparatus 1120 may perform various functions to implement schemes, techniques, processes and methods described herein pertaining to transmission and reception of random access preambles to aid integration of terrestrial mobile network communication and NTN communication, including various schemes described above as well as process 600 described below.

Each of apparatus 1110 and apparatus 1120 may be a part of an electronic apparatus, which may be a UE such as a portable or mobile apparatus, a wearable apparatus, a wireless communication apparatus or a computing apparatus. For instance, each of apparatus 1110 and apparatus 1120 may be implemented in a smartphone, a smartwatch, a personal digital assistant, a digital camera, or a computing equipment such as a tablet computer, a laptop computer or a notebook computer. Each of apparatus 1110 and apparatus 1120 may also be a part of a machine type apparatus, which may be an IoT or NB-IoT apparatus such as an immobile or a stationary apparatus, a home apparatus, a wire communication apparatus or a computing apparatus. For instance, each of apparatus 1110 and apparatus 1120 may be implemented in a smart thermostat, a smart fridge, a smart door lock, a wireless speaker or a home control center. Alternatively, each of apparatus 1110 and apparatus 1120 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Each of apparatus 1110 and apparatus 1120 may include at least some of those components shown in FIG. 11 such as a processor 1112 and a processor 1122, respectively. Each of apparatus 1110 and apparatus 1120 may further include one or more other components not pertinent to the proposed scheme of the present disclosure (e.g., internal power supply, display device and/or user interface device), and, thus, such component(s) of each of apparatus 1110 and apparatus 1120 are neither shown in FIG. 11 nor described below in the interest of simplicity and brevity.

In some implementations, at least one of apparatus 1110 and apparatus 1120 may be a part of an electronic apparatus, which may be a network node, a satellite or base station (e.g., eNB, gNB or TRP), a small cell, a router or a gateway. For instance, at least one of apparatus 1110 and apparatus 1120 may be implemented in an eNodeB in an LTE, LTE-Advanced or LTE-Advanced Pro network or in a gNB in a 5G, NR, IoT or NB-IoT network. Alternatively, at least one of apparatus 1110 and apparatus 1120 may be implemented in the form of one or more IC chips such as, for example and without limitation, one or more single-core processors, one or more multi-core processors, or one or more CISC or RISC processors.

In one aspect, each of processor 1112 and processor 1122 may be implemented in the form of one or more single-core processors, one or more multi-core processors, or one or more CISC or RISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including transmission and reception of random access preambles to aid integration of terrestrial mobile network communication and NTN communication in accordance with various implementations of the present disclosure.

In some implementations, apparatus 1110 may also include a transceiver 1116 coupled to processor 1112 and capable of wirelessly transmitting and receiving data. In some implementations, apparatus 1110 may further include a memory 1114 coupled to processor 1112 and capable of being accessed by processor 1112 and storing data therein. In some implementations, apparatus 1120 may also include a transceiver 1126 coupled to processor 1122 and capable of wirelessly transmitting and receiving data. In some implementations, apparatus 1120 may further include a memory 1124 coupled to processor 1122 and capable of being accessed by processor 1122 and storing data therein. Accordingly, apparatus 1110 and apparatus 1120 may wirelessly communicate with each other via transceiver 1116 and transceiver 1126, respectively.

To aid better understanding, the following description of the operations, functionalities and capabilities of each of apparatus 1110 and apparatus 1120 is provided in the context of an NB-IoT communication environment in which apparatus 1110 is implemented in or as a wireless communication device, a communication apparatus or a UE (e.g., UE 110) and apparatus 1120 is implemented in or as a network node (e.g., base station 120 or satellite 130).

In one aspect of transmission and reception of random access preambles to aid integration of terrestrial mobile network communication and NTN communication in accordance with the present disclosure, processor 1112 of apparatus 1110, as UE 110, may determine a location of an NT network node (e.g., satellite 130) of an NTN relative to apparatus 1110. Additionally, processor 1112 may compensate for either or both of a frequency shift and a propagation delay in transmission of a preamble in a random access procedure between apparatus 1110 and the NT network node based at least in part on the location of the NT network node relative to apparatus 1110.

In some implementations, in determining the location of the NT network node relative to apparatus 1110, processor 1112 may determine the location based on GNSS information and an ephemeris of the NT network node.

In some implementations, in compensating, processor 1112 may perform certain operations. For instance, processor 1112 may estimate a downlink frequency shift caused by a movement of the NT network node according to the location of the NT network node relative to apparatus 1110. Additionally, processor 1112 may pre-compensate for an uplink frequency shift before transmitting the preamble. In some implementations, in pre-compensating for the uplink frequency shift, processor 1112 may pre-compensate for the uplink frequency shift with respect to a point having a shortest propagation delay within coverage of a satellite beam of the NT network node.

In some implementations, in compensating, processor 1112 may perform certain operations. For instance, processor 1112 may estimate a residual Doppler frequency shift in an event that the NT network node performs downlink frequency pre-compensation. Moreover, processor 1112 may pre-compensate for an uplink frequency shift before transmitting the preamble.

In some implementations, in compensating, processor 1112 may perform certain operations. For instance, processor 1112 may approximate an uplink frequency shift by tracking a downlink frequency shift and a downlink propagation delay. Additionally, processor 1112 may pre-compensate for the uplink frequency shift before transmitting the preamble.

In some implementations, in compensating for either or both of the frequency shift and the propagation delay in the transmission of the preamble, processor 1112 may transmit, via transceiver 1116, a preamble sequence with mutually orthogonal symbols. In some implementations, the preamble sequence may include an M sequence, a Gold sequence, or a double-root ZC sequence.

In some implementations, in compensating for either or both of the frequency shift and the propagation delay in the transmission of the preamble, processor 1112 may perform certain operations. For instance, processor 1112 may extend either or both of a cyclic prefix and a guard interval with respect to the preamble. Moreover, processor 1112 may transmit, via transceiver 1116, the preamble to the NT network node. In some implementations, in extending either or both of the cyclic prefix and the guard interval, processor 1112 may perform either or both of: (a) extending the cyclic prefix of the preamble to be greater than or equal to a round-trip propagation delay plus a maximum multipath delay caused by a multipath propagation effect; and (b) extending the guard interval of the preamble to be greater than or equal to the round-trip propagation delay.

In some implementations, in compensating for either or both of the frequency shift and the propagation delay in the transmission of the preamble, processor 1112 may perform certain operations. For instance, processor 1112 may dynamically select, based on a priori information, a preamble pattern from a plurality of preamble patterns for preamble transmission. Additionally, processor 1112 may transmit, via transceiver 1116, the preamble to the NT network node with the selected preamble pattern. In some implementations, the a priori information may include at least information on an elevation angle of a beam of the NT network node with respect to apparatus 1110. In some implementations, in compensating for either or both of the frequency shift and the propagation delay in the transmission of the preamble, processor 1112 may receive, via transceiver 1116, the a priori information from a terrestrial network node of a terrestrial network via system messaging or dedicated signaling. In some implementations, the a priori information may further include information of a relative location between the NT network node and apparatus 1110, information of the terrestrial network, or a combination thereof.

In some implementations, in compensating for either or both of the frequency shift and the propagation delay in the transmission of the preamble, processor 1112 may compensate for the propagation delay by using segmentation of repetitive preamble sequences without a cyclic prefix and without sliding window detection.

In some implementations, processor 1112 may perform additional operations. For instance, processor 1112 may receive, via transceiver 1116, from a terrestrial network node (e.g., base station 120) of a terrestrial network an indication of an initial subcarrier range for preamble transmission. Moreover, processor 1112 may select one or more initial subcarriers from the range for the preamble transmission such that a same preamble sequence is used in communication with the terrestrial network node and the NT network node.

In another aspect of transmission and reception of random access preambles to aid integration of terrestrial mobile network communication and NTN communication in accordance with the present disclosure, processor 1112 of apparatus 1110, as UE 110, may determine an aspect of a preamble. Furthermore, processor 1112 may compensate for either or both of a frequency shift and a propagation delay in transmission of the preamble in a random access procedure between apparatus 1110 and an NT network node (e.g., satellite 130) of an NTN.

In some implementations, in determining the aspect of the preamble, processor 1112 may perform certain operations. For instance, processor 1112 may receive, via transceiver 1116, from a terrestrial network node (e.g., base station 120) of a terrestrial network an indication of an initial subcarrier range for preamble transmission. Additionally, processor 1112 may select one or more initial subcarriers from the range for the preamble transmission such that a same preamble sequence is used in communication with the terrestrial network node and the NT network node.

In some implementations, in determining the aspect of the preamble, processor 1112 may perform certain operations. For instance, processor 1112 may select a portion among a large-frequency-shift tolerance portion and a small-frequency-shift tolerance portion of available time-frequency resources for transmission of the preamble. Moreover, processor 1112 may dynamically adjust a ratio between the large-frequency-shift tolerance portion and the small-frequency-shift tolerance portion according to a priori information. In some implementations, the large-frequency-shift tolerance portion may include a first preamble pattern with guard intervals in a frequency domain and in a time domain, and the small-frequency-shift tolerance portion may include a second preamble pattern with no guard interval. Furthermore, the a priori information may include at least a satellite beam elevation angle with respect to apparatus 1110.

In some implementations, a division of the available time-frequency resources into the large-frequency-shift tolerance portion and the small-frequency-shift tolerance portion may be based on a density of users, a number of users that are simultaneously accessing a cell, the satellite beam elevation angle with respect to apparatus 1110, different common frequency shift compensation methods, or a combination thereof.

In some implementations, in compensating for either or both of the frequency shift and the propagation delay in the transmission of the preamble, processor 1112 may transmit, via transceiver 1116, a preamble sequence with mutually orthogonal symbols, and wherein the preamble sequence comprises an M sequence, a Gold sequence, or a double-root ZC sequence.

In some implementations, in compensating, processor 1112 may perform at least one of a plurality procedures. For instance, a first procedure of the plurality of procedures may involve: (i) estimating a downlink frequency shift caused by a movement of the NT network node according to the location of the NT network node relative to apparatus 1110; and (ii) pre-compensating for an uplink frequency shift before transmitting the preamble. A second procedure of the plurality of procedures may involve: (i) estimating a residual Doppler frequency shift in an event that the NT network node performs downlink frequency pre-compensation; and (ii) pre-compensating for the uplink frequency shift before transmitting the preamble. A third procedure of the plurality of procedures may involve: (i) approximating the uplink frequency shift by tracking the downlink frequency shift and a downlink propagation delay; and (ii) pre-compensating for the uplink frequency shift before transmitting the preamble. A fourth procedure of the plurality of procedures may involve: (i) extending either or both of a cyclic prefix and a guard interval with respect to the preamble; and (ii) transmitting, via transceiver 1116, the preamble to the NT network node. A fifth procedure of the plurality of procedures may involve performing either or both of: (a) extending the cyclic prefix of the preamble to be greater than or equal to a round-trip propagation delay plus a maximum multipath delay caused by a multipath propagation effect; and (b) extending the guard interval of the preamble to be greater than or equal to the round-trip propagation delay. A sixth procedure of the plurality of procedures may involve: (i) dynamically selecting, based on a priori information, a preamble pattern from a plurality of preamble patterns for preamble transmission; and (ii) transmitting, via transceiver 1116, the preamble to the NT network node with the selected preamble pattern. The a priori information may include at least information on an elevation angle of a beam of the NT network node with respect to apparatus 1110.

### Illustrative Processes

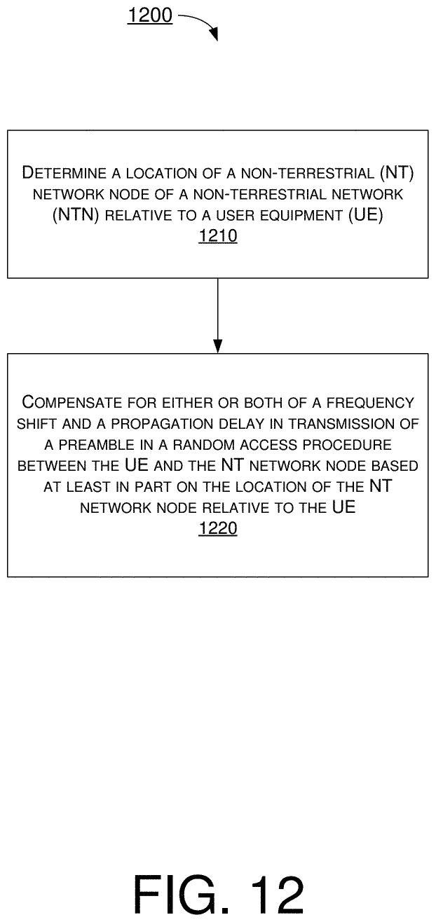

FIG. 12 illustrates an example process 1200 in accordance with an implementation of the present disclosure. Process 1200 may be an example implementation of the proposed schemes described above with respect to transmission and reception of random access preambles to aid integration of terrestrial mobile network communication and NTN communication in accordance with the present disclosure. Process 1200 may represent an aspect of implementation of features of apparatus 1110 and apparatus 1120. Process 1200 may include one or more operations, actions, or functions as illustrated by one or more of blocks 1210 and 1220. Although illustrated as discrete blocks, various blocks of process 1200 may be divided into additional blocks, combined into fewer blocks, or eliminated, depending on the desired implementation. Moreover, the blocks of process 1200 may executed in the order shown in FIG. 12 or, alternatively, in a different order. Process 1200 may also be repeated partially or entirely. Process 1200 may be implemented by apparatus 1110, apparatus 1120 and/or any suitable wireless communication device, UE, base station or machine type devices. Solely for illustrative purposes and without limitation, process 1200 is described below in the context of apparatus 1110 as a UE (e.g., UE 110) and apparatus 1120 as a network node (e.g., base station 120 or satellite 130). Process 1200 may begin at block 1210.

At 1210, process 1200 may involve processor 1112 of apparatus 1110, as UE 110, determining a location of an NT network node (e.g., satellite 130) of an NTN relative to apparatus 1110. Process 1200 may proceed from 1210 to 1220.

At 1220, process 1200 may involve processor 1112 compensating for either or both of a frequency shift and a propagation delay in transmission of a preamble in a random access procedure between apparatus 1110 and the NT network node based at least in part on the location of the NT network node relative to apparatus 1110.

In some implementations, in determining the location of the NT network node relative to apparatus 1110, process 1200 may involve processor 1112 determining the location based on GNSS information and an ephemeris of the NT network node.

In some implementations, in compensating, process 1200 may involve processor 1112 performing certain operations. For instance, process 1200 may involve processor 1112 estimating a downlink frequency shift caused by a movement of the NT network node according to the location of the NT network node relative to apparatus 1110. Additionally, process 1200 may involve processor 1112 pre-compensating for an uplink frequency shift before transmitting the preamble. In some implementations, in pre-compensating for the uplink frequency shift, process 1200 may involve processor 1112 pre-compensating for the uplink frequency shift with respect to a point having a shortest propagation delay within coverage of a satellite beam of the NT network node.

In some implementations, in compensating, process 1200 may involve processor 1112 performing certain operations. For instance, process 1200 may involve processor 1112 estimating a residual Doppler frequency shift in an event that the NT network node performs downlink frequency pre-compensation. Moreover, process 1200 may involve processor 1112 pre-compensating for an uplink frequency shift before transmitting the preamble.

In some implementations, in compensating, process 1200 may involve processor 1112 performing certain operations. For instance, process 1200 may involve processor 1112 approximating an uplink frequency shift by tracking a downlink frequency shift and a downlink propagation delay. Additionally, process 1200 may involve processor 1112 pre-compensating for the uplink frequency shift before transmitting the preamble.

In some implementations, in compensating for either or both of the frequency shift and the propagation delay in the transmission of the preamble, process 1200 may involve processor 1112 transmitting, via transceiver 1116, a preamble sequence with mutually orthogonal symbols. In some implementations, the preamble sequence may include an M sequence, a Gold sequence, or a double-root ZC sequence.

In some implementations, in compensating for either or both of the frequency shift and the propagation delay in the transmission of the preamble, process 1200 may involve processor 1112 performing certain operations. For instance, process 1200 may involve processor 1112 extending either or both of a cyclic prefix and a guard interval with respect to the preamble. Moreover, process 1200 may involve processor 1112 transmitting, via transceiver 1116, the preamble to the NT network node. In some implementations, in extending either or both of the cyclic prefix and the guard interval, process 1200 may involve processor 1112 performing either or both of: (a) extending the cyclic prefix of the preamble to be greater than or equal to a round-trip propagation delay plus a maximum multipath delay caused by a multipath propagation effect; and (b) extending the guard interval of the preamble to be greater than or equal to the round-trip propagation delay.

In some implementations, in compensating for either or both of the frequency shift and the propagation delay in the transmission of the preamble, process 1200 may involve processor 1112 performing certain operations. For instance, process 1200 may involve processor 1112 dynamically selecting, based on a priori information, a preamble pattern from a plurality of preamble patterns for preamble transmission. Additionally, process 1200 may involve processor 1112 transmitting, via transceiver 1116, the preamble to the NT network node with the selected preamble pattern. In some implementations, the a priori information may include at least information on an elevation angle of a beam of the NT network node with respect to apparatus 1110. In some implementations, in compensating for either or both of the frequency shift and the propagation delay in the transmission of the preamble, process 1200 may further involve processor 1112 receiving, via transceiver 1116, the a priori information from a terrestrial network node of a terrestrial network via system messaging or dedicated signaling. In some implementations, the a priori information may further include information of a relative location between the NT network node and apparatus 1110, information of the terrestrial network, or a combination thereof.

In some implementations, in compensating for either or both of the frequency shift and the propagation delay in the transmission of the preamble, process 1200 may involve processor 1112 compensating for the propagation delay by using segmentation of repetitive preamble sequences without a cyclic prefix and without sliding window detection.

In some implementations, process 1200 may involve processor 1112 performing additional operations. For instance, process 1200 may involve processor 1112 receiving, via transceiver 1116, from a terrestrial network node (e.g., base station 120) of a terrestrial network an indication of an initial subcarrier range for preamble transmission. Moreover, process 1200 may involve processor 1112 selecting one or more initial subcarriers from the range for the preamble transmission such that a same preamble sequence is used in communication with the terrestrial network node and the NT network node.

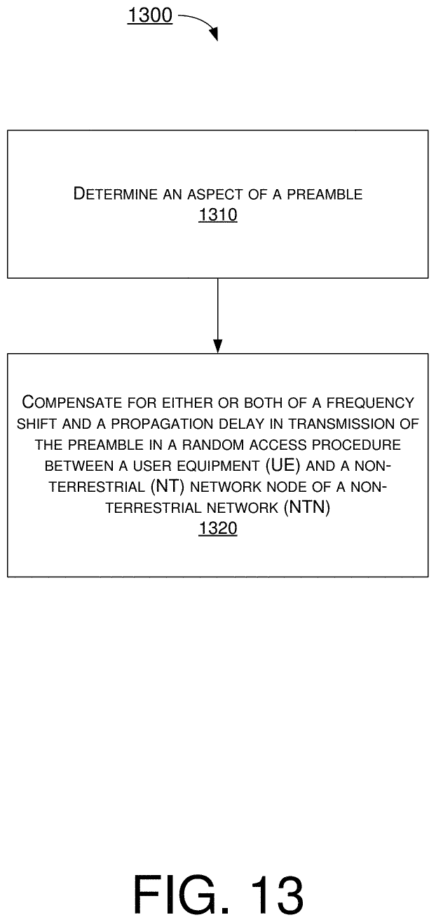

FIG. 13 illustrates an example process 1300 in accordance with an implementation of the present disclosure. Process 1300 may be an example implementation of the proposed schemes described above with respect to transmission and reception of random access preambles to aid integration of terrestrial mobile network communication and NTN communication in accordance with the present disclosure. Process 1300 may represent an aspect of implementation of features of apparatus 1110 and apparatus 1120. Process 1300 may include one or more operations, actions, or functions as illustrated by one or more of blocks 1310 and 1320. Although illustrated as discrete blocks, various blocks of process 1300 may be divided into additional blocks, combined into fewer blocks, or eliminated, depending on the desired implementation. Moreover, the blocks of process 1300 may executed in the order shown in FIG. 13 or, alternatively, in a different order. Process 1300 may also be repeated partially or entirely. Process 1300 may be implemented by apparatus 1110, apparatus 1120 and/or any suitable wireless communication device, UE, base station or machine type devices. Solely for illustrative purposes and without limitation, process 1300 is described below in the context of apparatus 1110 as a UE (e.g., UE 110) and apparatus 1120 as a network node (e.g., base station 120 or satellite 130). Process 1300 may begin at block 1310.

At 1310, process 1300 may involve processor 1112 of apparatus 1110, as UE 110, determining an aspect of a preamble. Process 1300 may proceed from 1310 to 1320.

At 1320, process 1300 may involve processor 1112 compensating for either or both of a frequency shift and a propagation delay in transmission of the preamble in a random access procedure between apparatus 1110 and an NT network node (e.g., satellite 130) of an NTN.

In some implementations, in determining the aspect of the preamble, process 1300 may involve processor 1112 performing certain operations. For instance, process 1300 may involve processor 1112 receiving, via transceiver 1116, from a terrestrial network node (e.g., base station 120) of a terrestrial network an indication of an initial subcarrier range for preamble transmission. Additionally, process 1300 may involve processor 1112 selecting one or more initial subcarriers from the range for the preamble transmission such that a same preamble sequence is used in communication with the terrestrial network node and the NT network node.

In some implementations, in determining the aspect of the preamble, process 1300 may involve processor 1112 performing certain operations. For instance, process 1300 may involve processor 1112 selecting a portion among a large-frequency-shift tolerance portion and a small-frequency-shift tolerance portion of available time-frequency resources for transmission of the preamble. Moreover, process 1300 may involve processor 1112 dynamically adjusting a ratio between the large-frequency-shift tolerance portion and the small-frequency-shift tolerance portion according to a priori information. In some implementations, the large-frequency-shift tolerance portion may include a first preamble pattern with guard intervals in a frequency domain and in a time domain, and the small-frequency-shift tolerance portion may include a second preamble pattern with no guard interval. Furthermore, the a priori information may include at least a satellite beam elevation angle with respect to apparatus 1110.

In some implementations, a division of the available time-frequency resources into the large-frequency-shift tolerance portion and the small-frequency-shift tolerance portion may be based on a density of users, a number of users that are simultaneously accessing a cell, the satellite beam elevation angle with respect to apparatus 1110, different common frequency shift compensation methods, or a combination thereof.

In some implementations, in compensating for either or both of the frequency shift and the propagation delay in the transmission of the preamble, process 1300 may involve processor 1112 transmitting, via transceiver 1116, a preamble sequence with mutually orthogonal symbols, and wherein the preamble sequence comprises an M sequence, a Gold sequence, or a double-root ZC sequence.

In some implementations, in compensating, process 1300 may involve processor 1112 performing at least one of a plurality procedures. For instance, a first procedure of the plurality of procedures may involve: (i) estimating a downlink frequency shift caused by a movement of the NT network node according to the location of the NT network node relative to apparatus 1110; and (ii) pre-compensating for an uplink frequency shift before transmitting the preamble. A second procedure of the plurality of procedures may involve: (i) estimating a residual Doppler frequency shift in an event that the NT network node performs downlink frequency pre-compensation; and (ii) pre-compensating for the uplink frequency shift before transmitting the preamble. A third procedure of the plurality of procedures may involve: (i) approximating the uplink frequency shift by tracking the downlink frequency shift and a downlink propagation delay; and (ii) pre-compensating for the uplink frequency shift before transmitting the preamble. A fourth procedure of the plurality of procedures may involve: (i) extending either or both of a cyclic prefix and a guard interval with respect to the preamble; and (ii) transmitting, via transceiver 1116, the preamble to the NT network node. A fifth procedure of the plurality of procedures may involve performing either or both of: (a) extending the cyclic prefix of the preamble to be greater than or equal to a round-trip propagation delay plus a maximum multipath delay caused by a multipath propagation effect; and (b) extending the guard interval of the preamble to be greater than or equal to the round-trip propagation delay. A sixth procedure of the plurality of procedures may involve: (i) dynamically selecting, based on a priori information, a preamble pattern from a plurality of preamble patterns for preamble transmission; and (ii) transmitting, via transceiver 1116, the preamble to the NT network node with the selected preamble pattern. The a priori information may include at least information on an elevation angle of a beam of the NT network node with respect to apparatus 1110.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
determining a location of a non-terrestrial (NT) network node of a non-terrestrial network (NTN) relative to a user equipment (UE); and
compensating for either or both of a frequency shift and a propagation delay in transmission of a preamble in a random access procedure between the UE and the NT network node based at least in part on the location of the NT network node relative to the UE.

2. The method of claim 1, wherein the determining of the location of the NT network node relative to the UE comprises determining the location based on Global Navigation Satellite System (GNSS) information and an ephemeris of the NT network node.

3. The method of claim 1, wherein the compensating comprises:
estimating, by the UE, a downlink frequency shift caused by a movement of the NT network node according to the location of the NT network node relative to the UE; and
pre-compensating, by the UE, for an uplink frequency shift before transmitting the preamble.

4. The method of claim 3, wherein the pre-compensating for the uplink frequency shift comprises pre-compensating for the uplink frequency shift with respect to a point having a shortest propagation delay within coverage of a satellite beam of the NT network node.

5. The method of claim 1, wherein the compensating comprises:
estimating, by the UE, a residual Doppler frequency shift in an event that the NT network node performs downlink frequency pre-compensation; and
pre-compensating, by the UE, for an uplink frequency shift before transmitting the preamble.

6. The method of claim 1, wherein the compensating comprises:
approximating, by the UE, an uplink frequency shift by tracking a downlink frequency shift and a downlink propagation delay; and
pre-compensating, by the UE, for the uplink frequency shift before transmitting the preamble.

7. The method of claim 1, wherein the compensating for either or both of the frequency shift and the propagation delay in the transmission of the preamble comprises transmitting a preamble sequence with mutually orthogonal symbols.

8. The method of claim 7, wherein the preamble sequence comprises an M sequence, a Gold sequence, or a double-root Zadoff-Chu (ZC) sequence.

9. The method of claim 1, wherein the compensating for either or both of the frequency shift and the propagation delay in the transmission of the preamble comprises:
extending, by the UE, either or both of a cyclic prefix and a guard interval with respect to the preamble; and
transmitting, by the UE, the preamble to the NT network node.

10. The method of claim 9, wherein the extending of either or both of the cyclic prefix and the guard interval comprises performing either or both of:
extending the cyclic prefix of the preamble to be greater than or equal to a round-trip propagation delay plus a maximum multipath delay caused by a multipath propagation effect; and
extending the guard interval of the preamble to be greater than or equal to the round-trip propagation delay.

11. The method of claim 1, wherein the compensating for either or both of the frequency shift and the propagation delay in the transmission of the preamble comprises:
dynamically selecting, by the UE based on a priori information, a preamble pattern from a plurality of preamble patterns for preamble transmission; and
transmitting, by the UE, the preamble to the NT network node with the selected preamble pattern,
wherein the a priori information comprises at least information on an elevation angle of a beam of the NT network node with respect to the UE.

12. The method of claim 11, wherein the compensating for either or both of the frequency shift and the propagation delay in the transmission of the preamble further comprises:
receiving, by the UE, the a priori information from a terrestrial network node of a terrestrial network via system messaging or dedicated signaling,
wherein the a priori information further comprises information of a relative location between the NT network node and the UE, information of the terrestrial network, or a combination thereof

13. The method of claim 1, wherein the compensating for either or both of the frequency shift and the propagation delay in the transmission of the preamble comprises compensating for the propagation delay by using segmentation of repetitive preamble sequences without a cyclic prefix and without sliding window detection.

14. The method of claim 1, further comprising:
receiving, by the UE, from a terrestrial network node of a terrestrial network an indication of an initial subcarrier range for preamble transmission; and
selecting, by the UE, one or more initial subcarriers from the range for the preamble transmission such that a same preamble sequence is used in communication with the terrestrial network node and the NT network node.

15. A method, comprising:
determining an aspect of a preamble; and
compensating for either or both of a frequency shift and a propagation delay in transmission of the preamble in a random access procedure between a user equipment (UE) and a non-terrestrial (NT) network node of a non-terrestrial network (NTN).

16. The method of claim 15, wherein the determining of the aspect of the preamble comprises:
receiving, by the UE, from a terrestrial network node of a terrestrial network an indication of an initial subcarrier range for preamble transmission; and
selecting, by the UE, one or more initial subcarriers from the range for the preamble transmission such that a same preamble sequence is used in communication with the terrestrial network node and the NT network node.

17. The method of claim 15, wherein the determining of the aspect of the preamble comprises:
selecting, by the UE, a portion among a large-frequency-shift tolerance portion and a small-frequency-shift tolerance portion of available time-frequency resources for transmission of the preamble; and
dynamically adjusting, by the UE, a ratio between the large-frequency-shift tolerance portion and the small-frequency-shift tolerance portion according to a priori information,
wherein the large-frequency-shift tolerance portion comprises a first preamble pattern with guard intervals in a frequency domain and in a time domain,
wherein the small-frequency-shift tolerance portion comprises a second preamble pattern with no guard interval, and
wherein the a priori information comprises at least a satellite beam elevation angle with respect to the UE.

18. The method of claim 17, wherein a division of the available time-frequency resources into the large-frequency-shift tolerance portion and the small-frequency-shift tolerance portion is based on a density of users, a number of users that are simultaneously accessing a cell, the satellite beam elevation angle with respect to the UE, different common frequency shift compensation methods, or a combination thereof.

19. The method of claim 15, wherein the compensating for either or both of the frequency shift and the propagation delay in the transmission of the preamble comprises transmitting a preamble sequence with mutually orthogonal symbols, and wherein the preamble sequence comprises an M sequence, a Gold sequence, or a double-root Zadoff-Chu (ZC) sequence.

20. The method of claim 15, wherein the compensating comprises performing at least one of a plurality procedures, and wherein:
a first procedure of the plurality of procedures comprises:
estimating, by the UE, a downlink frequency shift caused by a movement of the NT network node according to the location of the NT network node relative to the UE; and
pre-compensating, by the UE, for an uplink frequency shift before transmitting the preamble,
a second procedure of the plurality of procedures comprises:
estimating, by the UE, a residual Doppler frequency shift in an event that the NT network node performs downlink frequency pre-compensation; and
pre-compensating, by the UE, for the uplink frequency shift before transmitting the preamble,
a third procedure of the plurality of procedures comprises:
approximating, by the UE, the uplink frequency shift by tracking the downlink frequency shift and a downlink propagation delay; and
pre-compensating, by the UE, for the uplink frequency shift before transmitting the preamble,
a fourth procedure of the plurality of procedures comprises:
extending, by the UE, either or both of a cyclic prefix and a guard interval with respect to the preamble; and
transmitting, by the UE, the preamble to the NT network node,
a fifth procedure of the plurality of procedures comprises performing either or both of:
extending the cyclic prefix of the preamble to be greater than or equal to a round-trip propagation delay plus a maximum multipath delay caused by a multipath propagation effect; and
extending the guard interval of the preamble to be greater than or equal to the round-trip propagation delay,
a sixth procedure of the plurality of procedures comprises:
dynamically selecting, by the UE based on a priori information, a preamble pattern from a plurality of preamble patterns for preamble transmission; and
transmitting, by the UE, the preamble to the NT network node with the selected preamble pattern,
wherein the a priori information comprises at least information on an elevation angle of a beam of the NT network node with respect to the UE.
